(19) United States
(12) Patent Application Publication
(10) Pub. No.: US 2018/0141675 A1
(43) Pub. Date: May 24, 2018

(54) AUXILIARY POWER UNIT WITH SOLID OXIDE FUEL CELL FOR AN AIRCRAFT

(71) Applicant: GE Aviation Systems Limited, Cheltenham (GB)

(72) Inventors: Colin John HALSEY, Tewkesbury (GB); Michael David BAILEY, Tewkesbury (GB)

(21) Appl. No.: 15/814,464

(22) Filed: Nov. 16, 2017

(30) Foreign Application Priority Data
Nov. 16, 2016 (GB) 1619403.7

(51) Int. Cl. B64D 41/00; H01M 8/1253; H01M 8/04276; H01M 8/04007; B64D 37/30; F02C 3/04; F02C 6/04; F02C 7/268; F02C 6/18; H02J 7/34; H02K 7/18; F02C 6/10

(52) U.S. Cl. CPC B64D 41/00; H01M 8/1253; H01M 8/04276; H01M 8/04007; B64D 37/30; F02C 3/04; H01M 2008/1293; F02C 7/268; F02C 6/18; H02J 7/34; H02K 7/1823; F02C 6/10; F02C 6/04

(57) ABSTRACT

An auxiliary power unit and a method for providing electricity to an aircraft with the auxiliary power unit where the auxiliary power unit includes a turbine with a compressor and an output shaft. A combustor coupled to the turbine and to a fuel source, and a solid oxide fuel cell coupled to the combustor, the compressor and to the fuel source.

### BACKGROUND OF THE INVENTION

An auxiliary power unit (APU) system provides a mix of pneumatic, hydraulic, and electrical power through components added to the shaft of the gas turbine engine. The shaft output power can vary due to being controlled primarily by the flow of fuel.

In conventional APU systems, a dedicated starter motor is operated during a starting sequence to bring a gas turbine engine up to self-sustaining speed, and then the engine is accelerated to operating speed. Once this condition is reached, a generator is coupled to and driven by the gas turbine engine during operation whereupon the generator develops electrical power. The APU must provide constant electric power over the full range of flight speed, altitudes, ambient temperatures and other conditions.

A solid oxide fuel cell (SOFC) provides direct current (DC) electrical power from a chemical process. When coupled to a gas turbine engine, byproducts from the SOFC such as oxygen and unreacted hydrogen can be utilized to condition the air used by the SOFC and increase the efficiency of the entire system. Adding an SOFC directly to an APU as its fuel source would be beyond the energy available by any byproducts, a modified combination, however, could increase efficiency.

### BRIEF DESCRIPTION OF THE INVENTION

In one aspect of the present disclosure, an auxiliary power unit for an aircraft comprising a turbine including a compressor and an output shaft a combustor coupled to the turbine and to a fuel source, and a solid oxide fuel cell coupled to the combustor, the compressor, and to the fuel source and having a power output wherein compressed air from the compressor and fuel from the fuel source act in the solid oxide fuel cell to generate electricity at the power output, and unreacted fuel from the solid oxide fuel cell and fuel from the fuel source combust in the combustor to power the compressor and the output shaft in the turbine.

In another aspect of the present disclosure, an aircraft comprising an auxiliary power unit having a turbine including a compressor and an output shaft, a combustor coupled to the turbine and to a fuel source, and a solid oxide fuel cell coupled to the combustor, the compressor, and to the fuel source and having a power output, wherein compressed air from the compressor and fuel from the fuel source act in the solid oxide fuel cell to generate electricity at the power output, and unreacted fuel from the solid oxide fuel cell and fuel from the fuel source combust in the combustor to power the compressor and the output shaft in the turbine.

In yet another aspect of the present disclosure, a method of providing electricity to an aircraft comprising supplying compressed air from a turbine compressor in an auxiliary power unit to a solid oxide fuel cell, supplying fuel to the solid oxide fuel cell, directing unreacted fuel from the solid oxide fuel cell to a combustor in the auxiliary power unit, and delivering electricity from the solid oxide fuel cell to the aircraft.

### BRIEF DESCRIPTION OF THE DRAWINGS

In the drawings:

FIG. 1 is a perspective view of an aircraft having an auxiliary power unit (APU) system in accordance with various aspects described herein.

FIG. 2 is a schematic of an auxiliary power unit system in accordance with various aspects described herein.

FIG. 3 is a schematic of an solid oxide fuel cell in accordance with various aspects described

FIG. 4 is schematic of another auxiliary power unit system in accordance with various aspects described herein.

FIG. 5 is a flow chart illustrated a method for providing electricity to an aircraft using the auxiliary power unit system in accordance with various aspect described herein.

### DESCRIPTION OF EMBODIMENTS OF THE INVENTION

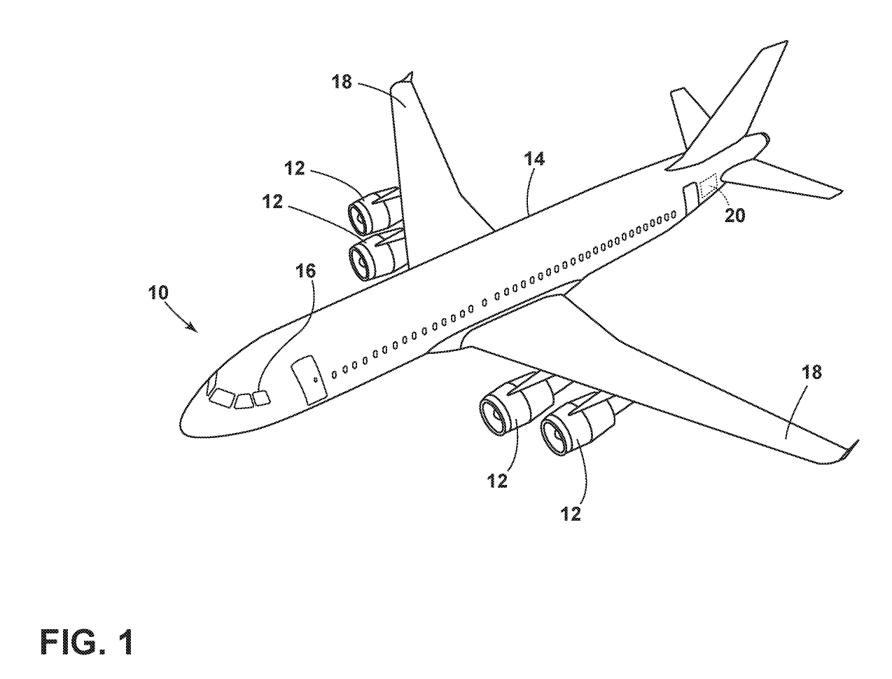

FIG. 1 illustrates an embodiment of the disclosure, showing an aircraft 10 that includes an auxiliary power unit (APU) system 20, schematically illustrated. It should be understood that while the APU system 20 described herein is by way of a non-limiting example in the context of an aircraft, APU systems 20 are used in other industries such as marine and automotive industries.

The aircraft 10 can include multiple engines, such as gas turbine engines 12, a fuselage 14, a cockpit 16 positioned in the fuselage 14, and wing assemblies 18 extending outward from the fuselage 14.

While a commercial aircraft 10 has been illustrated, it is contemplated that embodiments of the invention can be used in any type of aircraft 10. Further, while two gas turbine engines 12 have been illustrated on the wing assemblies 18, it will be understood that any number of gas turbine engines 12 including a single gas turbine engine 12 on the wing assemblies 18, or even a single gas turbine engine mounted in the fuselage 14 can be included.

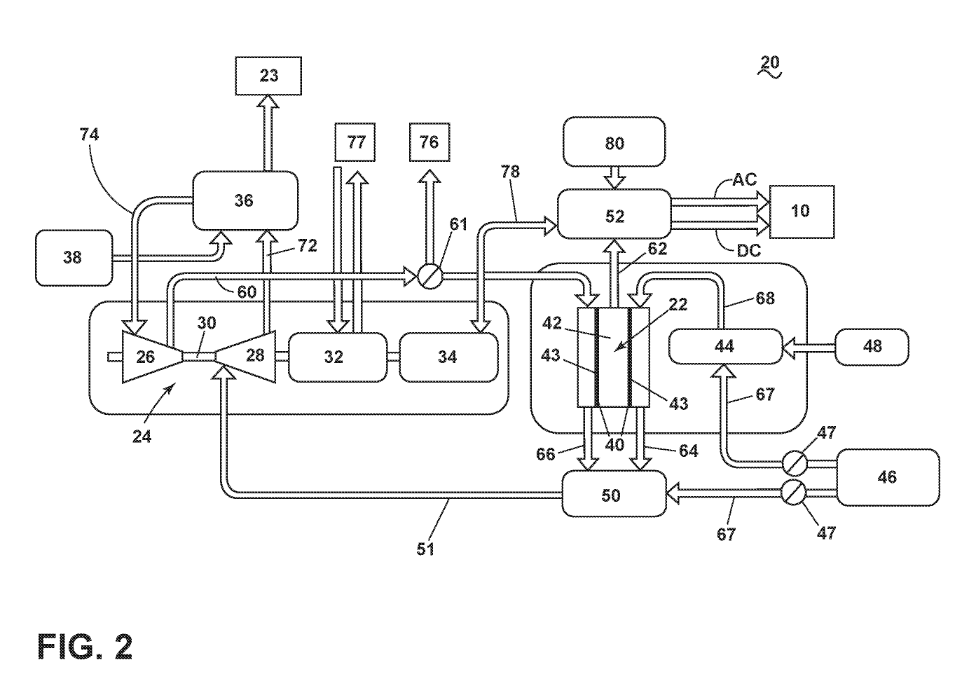

FIG. 2 illustrates the APU system 20 with a solid oxide fuel cell (SOFC) 22 and an exhaust 23. The APU system 20 includes a turbine 24 including a compressor 26 and a turbine section 28 connected by an output shaft 30 which is further coupled by way of a non-limiting example to a hydraulic pump 32 and a starter generator 34. Other auxiliary systems can also be contemplated such as air conditioning, oil cooling, fuel pumping or the like. The turbine is further coupled to a heat exchanger 36 that is coupled to an air source 38 and the exhaust 23.

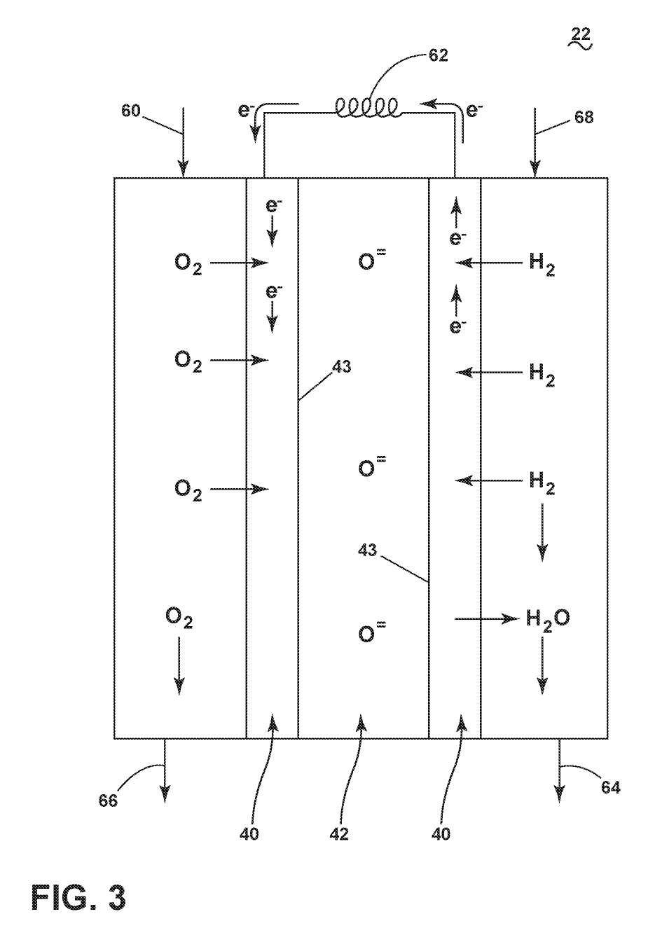

FIG. 3 is a schematic of the SOFC 22 consisting of a pair of electrodes 40 with an electrolyte 42 in between which together form a power output 62. At least one electrode 40 is a thin porous electron e⁻ conductor, having a porosity to allow fuel H₂ to diffuse from an outer surface of the electrode 40 to an electrode/electrolyte interface 43. Air O₂ is provided such that when introduced to the other of the two electrodes 40, produces oxidant ions O⁼. The electrolyte 42 in an SOFC allows the movement of oxidant ions O⁼ to fuel H₂ and is a fully dense oxygen ion conductor. The fuel H₂ and oxidant ions O⁻ react and produce water H₂O, electrons e⁻ and heat. Other by-products include carbon dioxide. The full density prevents the gaseous fuel from contacting with air and burning. The most commonly used electrolyte is a ceramic material Zirconium stabilized with Yttrium oxide. It is understood that other electrolytes can be contemplated and Zirconium is a non-limiting example.

The SOFC 22 is made of any appropriate solid material and can be formed in rolled tubes. The SOFC 22 requires high operating temperatures (800-1000° C.) and can be run on a variety of hydrocarbon fuels including by way of non-limiting example natural gas.

Turning back to FIG. 2, the SOFC 22 is coupled to a pre-reformer 44. The pre-reformer 44 can be added to condition fuel 67 from a fuel source 46 into a light hydrocarbon fuel 68 for use directly by the SOFC 22. The pre-reformer 44 is coupled to a source of water 48 to enable the conditioning process. Fuel provided by the fuel source 46 is controlled by a set of valves 47.

A combustor 50 is coupled to the turbine 24, the SOFC 22, and to the fuel source 46. It is contemplated that unreacted fuel 64 continues on to the combustor 50 from the SOFC 22. Combusted fuel 51 is provided to the turbine section 28 of the turbine 24. Additionally, all electrical generating devices are fed into a power conditioning unit 52 to output aircraft 10 quality electrical supplies both as 3Ø AC or DC as required.

In order to start the APU system 20 the SOFC 22 and optional pre-reformer 44 must be pre-heated, by way of non-limiting example using an external electrical component, to close to their operating temperature after which the starter generator 34 drives the output shaft 30 creating compressed air 60 for the SOFC 22. The compressed air 60 along with fuel 68 that has been processed in the pre-reformer 44 react in the SOFC 22 to generate electricity at the power output 62.

Power supplied by the output shaft 30 is governed primarily by the supply of fuel 64, 67 and is therefore variable. SOFC unreacted fuel 64 and additional fuel 67 can be supplied to be burnt in the combustor 50 to increase power available to the output shaft 30. This in turn increases the power available from the output shaft 30 driven devices, for example the hydraulic pump 32 and the starter generator 34.

The SOFC 22 provides unreacted fuel 64 and air 66, which are provided to the combustor 50 to power the compressor 26 via the turbine 28. Using the unreacted fuel 64 and air 66 from the SOFC 22 in the combustor increases efficiency of the turbine 24. The combustor 50 also receives fuel 67 from the fuel source 46.

Air 70 is provided to the heat exchanger 36 where it is heated by exhaust gases 72 from the turbine section 28 to become heated air 74 prior to compression in the compressor 26. The compressed air 60 is controlled, by for example a valve 61, and supplied to the SOFC 22 and pneumatic power 76. Hydraulic power 77 is directly supplied by the hydraulic pump 32.

At this point the system is self-sustaining so the starter generator 34 can be used to generate AC electrical power output 78 if required. A battery supply 80, which by way of a non-limiting example can be batteries or super capacitors, can be coupled to the power conditioning unit 52 as well to deliver supplemental power sources.

The APU system 20 described herein increases efficiency over existing APU systems by utilizing an SOFC as the main electrical power source and combusting the unburnt fuel from the SOFC 22 to provide compressed heated air 74 by way of the heat exchanger 36.

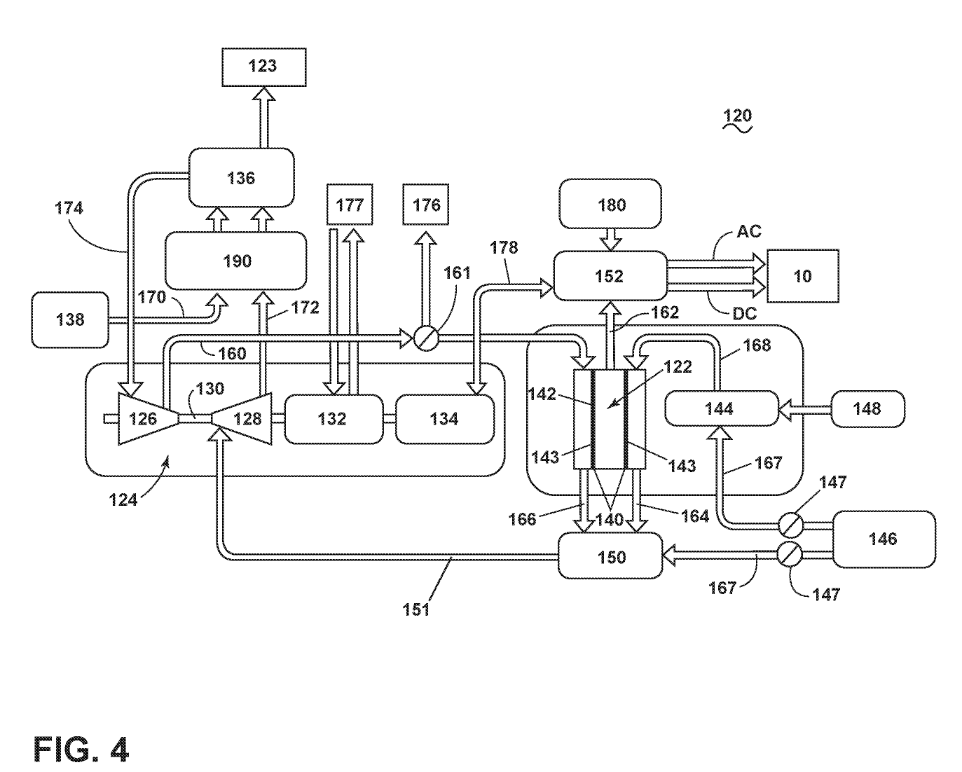

Turning to FIG. 4, it is also contemplated that the efficiency of an APU system 120 can be even further enhanced by the inclusion of a thermal electric generator (TEG) 190. The APU system 120 is similar to the APU system 20, therefore like parts will be identified with like numerals increased by 100, with it being understood that the description of the like parts of the APU system 20 applies to the APU system 120, unless otherwise noted.

The TEG 190 is coupled to a turbine 124 and an air source 138 in order to recover any wasted heat from exhaust gases 172 provided from a turbine section 128. The TEG 190 is further coupled to a heat exchanger 136 where air 170 is heated and heated air 172 is provided to a compressor 126.

TEGs 190 use a temperature differential to create electrical power. TEGs require very low thermal resistance and thus are ideally suited to constant large temperature differentials being maintained by fast flowing gases. Temperature differentials between the air supplied 170 and the exhaust gases 172 can reach 800° C. The TEG 190 is therefore further coupled to the power conditioning unit 152 to deliver additional electrical power 178, in the form of low voltage high current output. A starter generator 134, an SOFC 122, and a battery supply 180 are also coupled to the power conditioning unit 152.

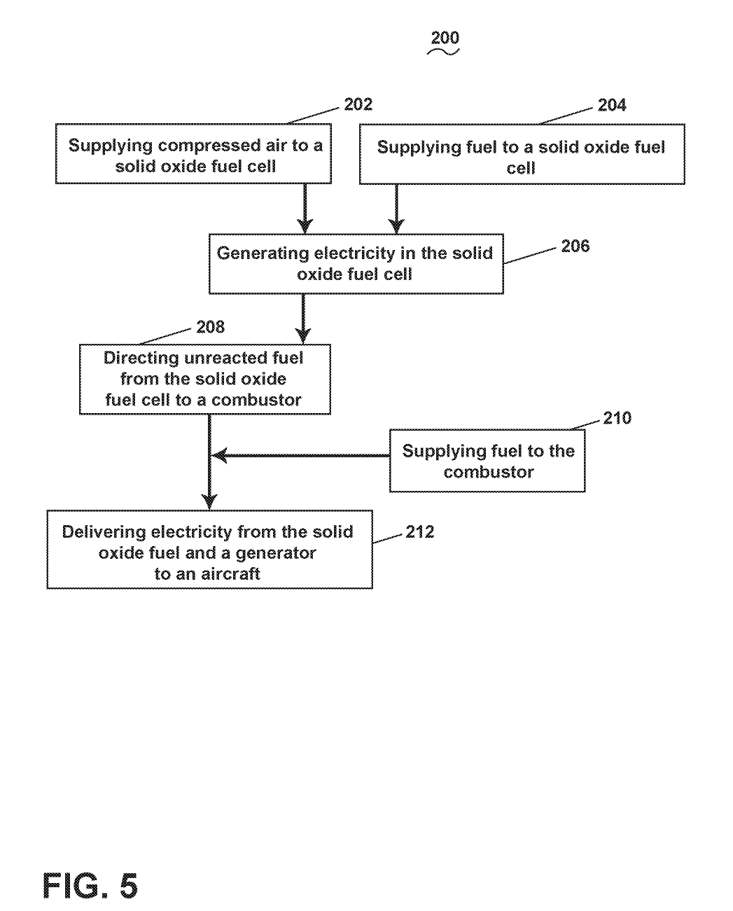

Turning to FIG. 5, a flow chart illustrates a method 200 of providing electricity to an aircraft where at 202 compressed air 60 is supplied to the SOFC 22 and at 204 conditioned fuel 68, is supplied to the SOFC 22. Conditioning the fuel 67 can include heating the fuel 67. At 206 electricity is generated by the fuel cell after which at 208 unreacted fuel 64 and air 66 from the SOFC 22 is directed to the combustor 50. Fuel 67 from the fuel source 46 is simultaneously supplied to the combustor 50 at 210. The hot gases drive a turbine 28 which powers a generator 34 generating supplemental electricity. Finally at 212, the electricity generated by the SOFC 22 and generator 34 is delivered to the aircraft 10. It is further contemplated that exhaust gas 72 from the combustor 50 can be received in the TEG 190 after which the TEG 190 can feed electricity to the aircraft 10.

It should be understood that the method 200 applies to all APU systems 20, 120 described herein and is described with respect to APU system 20 for clarity and is not meant to be limiting.

The APU system 20, 120 as described herein is a modified solid oxide fuel cell-gas turbine (SOFC-GT) system that provides all the functionality of a convention aviation APU system with increased efficiency and lower emissions. Conventional APU systems average a 15% efficiency and an SOFC-GT can be greater than 60% efficiency, but does not have the capability of providing pneumatic 76 and hydraulic 77 power and support the SOFC at the same time.

Benefits to the APU system described herein include lower emissions and lower fuel consumption while still providing all the functionality of a conventional APU system. The configuration described herein can be used on an existing aircraft providing cost savings. During taxiing, the APU system can be used for an electric taxiing system and correspond with lower airport emission requirements.

Additional benefits include the use of an APU system more frequently during flight and can operate with multiple types of fuels. It is also noted that the output shaft 30 has a power input independent of the SOFC 22 outputs 64, 66.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. Moreover, while “a set of” various elements have been described, it will be understood that “a set” can include any number of the respective elements, including only one element. Combinations or permutations of features described herein are covered by this disclosure.

This written description uses examples to disclose embodiments of the invention, including the best mode, and also to enable any person skilled in the art to practice embodiments of the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An auxiliary power unit for an aircraft comprising:
a turbine including a compressor and an output shaft;
a combustor coupled to the turbine and to a fuel source; and
a solid oxide fuel cell coupled to the combustor, the compressor, and to the fuel source and having a power output;
wherein compressed air from the compressor and fuel from the fuel source undergo a chemical reaction in the solid oxide fuel cell to generate electricity at the power output, and unreacted fuel from the solid oxide fuel cell and fuel from the fuel source combust in the combustor to power the compressor and the output shaft in the turbine.

2. The auxiliary power unit of claim 1 further comprising a starter generator electrically connected to the power output.

3. The auxiliary power unit of claim 1 further comprising a pre-reformer between the solid oxide fuel cell and the fuel source to condition the fuel before entering the solid oxide fuel cell.

4. The auxiliary power unit of claim 1 further comprising a power conditioning unit coupled to the power output.

5. The auxiliary power unit of claim 4 further comprising a battery supply coupled to the power conditioning unit.

6. The auxiliary power unit of claim 1 wherein the turbine includes an exhaust and a heat exchanger is connected to the exhaust.

7. The auxiliary power unit of claim 6 further comprising a thermal electric generator connected between the exhaust and the heat exchanger.

8. The auxiliary power unit of claim 7 wherein the thermal electric generator is connected to a power conditioning unit coupled to the power output.

9. The auxiliary power unit of claim 1 where the chemical reaction takes place in a pair of electrodes yielding oxidant ions, electrons, water, and carbon dioxide.

10. An aircraft comprising:
an auxiliary power unit having a turbine including a compressor and an output shaft;
a combustor coupled to the turbine and to a fuel source; and
a solid oxide fuel cell coupled to the combustor, the compressor, and to the fuel source and having a power output;
wherein compressed air from the compressor and fuel from the fuel source act in the solid oxide fuel cell to generate electricity at the power output, and unreacted fuel from the solid oxide fuel cell and fuel from the fuel source combust in the combustor to power the compressor and the output shaft in the turbine.

11. The aircraft of claim 10 further comprising a starter generator electrically connected to the power output.

12. The aircraft of claim 10 further comprising a pre-reformer between the solid oxide fuel cell and the fuel source to condition the fuel before entering the solid oxide fuel cell.

13. The aircraft of claim 10 further comprising a power conditioning unit coupled to the power output.

14. The aircraft of claim 13 further comprising a battery supply coupled to the power conditioning unit.

15. The aircraft of claim 10 wherein the turbine includes an exhaust and a heat exchanger is connected to the exhaust.

16. The aircraft of claim 15 further comprising a thermal electric generator connected between the exhaust and the heat exchanger.

17. A method of providing electricity to an aircraft comprising:
supplying compressed air from a turbine compressor in an auxiliary power unit to a solid oxide fuel cell;
supplying fuel to the solid oxide fuel cell;
generating electricity in the solid oxide fuel cell;
directing unreacted fuel from the solid oxide fuel cell to a combustor in the auxiliary power unit;
supplying fuel to the combustor; and
delivering electricity from the solid oxide fuel cell to the aircraft.

18. The method of claim 17 further comprising conditioning the fuel before supplying the fuel to the solid oxide fuel cell.

19. The method of claim 18 wherein conditioning includes heating the fuel.

20. The method of claim 17 further comprising directing exhaust gas from the combustor to a thermal electric generator, and delivering electricity from the thermal electric generator to the aircraft.
